(19) United States
(12) Patent Application Publication
(10) Pub. No.: US 2020/0173619 A1
(43) Pub. Date: Jun. 4, 2020

(54) FLUID DISPLAY DEVICE

(71) Applicant: Sony Interactive Entertainment LLC, San Mateo, CA (US)

(72) Inventors: Charles McCoy, San Diego, CA (US); True Xiong, San Diego, CA (US); Blaine Morgan, Escondido, CA (US)

(21) Appl. No.: 16/702,274

(22) Filed: Dec. 3, 2019

Related U.S. Application Data
(60) Provisional application No. 62/775,291, filed on Dec. 4, 2018.

(51) Int. Cl. F21S 10/00; G09F 13/24

(52) U.S. Cl. CPC F21S 10/002; F21Y 2115/10; G09F 13/24

(57) ABSTRACT

A fluid display device has a plurality of liquid outlet nozzles configured to emit liquid droplets. The nozzles are arranged in a horizontal row, a plurality of light emitters aligned with a vertical travel path of the liquid droplets and coplanar with a vertical plane of the falling liquid droplets. The light emitters are configured to illuminate the droplets. A controller synchronizes illumination of the liquid droplets with pixels in an image. A pattern of illumination of the droplets creates a visible image in the vertical plane of the falling liquid droplets.

### CLAIM OF PRIORITY

This application claims the priority benefit of U.S. Provisional Patent Application No. 62/775,291, filed Dec. 4, 2018, the entire contents of which are incorporated herein by reference for all purposes.

### FIELD OF THE DISCLOSURE

The present disclosure relates to display devices. Specifically the present disclosure relates to display devices that use fluid droplets as a display medium.

### BACKGROUND OF THE INVENTION

Fountains and other water features have been used as attractive elements in gardens and corporate lobbies. Images have been projected onto fountains and ponds to create interesting looking attractions. These projected images require projectors placed out of plane from the area on which the images are projected. Positioning the projector out of plane from the display requires additional space and can be an unattractive. Additionally images projected on to fountains or other water features are only viewable from one direction.

It is within this context that embodiments of the present disclosure arise.

### BRIEF DESCRIPTION OF THE DRAWINGS

The aspects of the present disclosure can be readily understood by considering the following detailed description in conjunction with the accompanying drawings, in which:

FIG. 1A depicts a diagram of the front view of the fluid display device according to aspects of the present disclosure.

FIG. 1B shows a diagram of the side view of the fluid display device according to aspects of the present disclosure.

FIG. 2 depicts a diagram of the front view of a full color fluid display device according to aspects of the present disclosure.

FIG. 3 shows a diagram of the front view of a fluid display device with top-mounted diagonal light emitters according to aspects of the present disclosure.

FIG. 4 depicts a diagram of the front view of the fluid display device having light emitters mounted on an incline according to aspects of the present disclosure.

FIG. 5 shows a block diagram of a system incorporating the fluid display device according to aspects of the present disclosure.

FIG. 6A depicts a schematic diagram of the conversion of image frames to fluid images with the fluid display device according to aspects of the present disclosure.

FIG. 6B depicts a block diagram of the conversion of image frames to fluid images with the fluid display device according to aspects of the present disclosure.

FIG. 7 shows a diagram of the side view of the fluid display device having multiple rows of liquid nozzles according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the disclosure. Accordingly, examples of embodiments of the disclosure described below are set forth without any loss of generality to, and without imposing limitations upon, the claimed disclosure.

While numerous specific details are set forth in order to provide a thorough understanding of embodiments of the disclosure, it will be understood by those skilled in the art that other embodiments may be practiced without these specific details. In other instances, well-known methods, procedures, components and circuits have not been described in detail so as not to obscure the present disclosure. Some portions of the description herein are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm, as used herein, is a self-consistent sequence of actions or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Unless specifically stated or otherwise as apparent from the following discussion, it is to be appreciated that throughout the description, discussions utilizing terms such as “processing”, “computing”, “converting”, “reconciling”, “determining” or “identifying,” refer to the actions and processes of a computer platform which is an electronic computing device that includes a processor which manipulates and transforms data represented as physical (e.g., electronic) quantities within the processor's registers and accessible platform memories into other data similarly represented as physical quantities within the computer platform memories, processor registers, or display screen.

A computer program may be stored in a computer readable storage medium, such as, but not limited to, any type of disk including floppy disks, optical disks (e.g., compact disc read only memory (CD-ROMs), digital video discs (DVDs), Blu-Ray Discs™, etc.), and magnetic-optical disks, read-only memories (ROMs), random access memories (RAMs), EPROMs, EEPROMs, magnetic or optical cards, flash memories, or any other type of non-transitory media suitable for storing electronic instructions.

The terms “coupled” and “connected,” along with their derivatives, may be used herein to describe structural relationships between components of the apparatus for performing the operations herein. It should be understood that these terms are not intended as synonyms for each other. Rather, in particular embodiments, “connected” may be used to indicate that two or more elements are in direct physical or electrical contact with each other. In some instances, “connected”, “connection”, and their derivatives are used to indicate a logical relationship, e.g., between node layers in a neural network (NN). “Coupled” may be used to indicated that two or more elements are in either direct or indirect (with other intervening elements between them) physical or electrical contact with each other, and/or that the two or more elements co-operate or communicate with each other (e.g., as in a cause an effect relationship).

In the following Description, reference is made to the accompanying drawings, which form a part hereof, and in which is shown by way of illustration specific embodiments in which the claimed invention may be practiced. In this regard, directional terminology, such as “top,” “bottom,”, “above”, “below”, “front,” “back,” “leading,” “trailing,” etc., is used with reference to the orientation of the figure(s) being described. Because certain components described herein can be positioned in a number of different orientations, the directional terminology is used for purposes of illustration and is in no way limiting. It is to be understood that other embodiments may be utilized and structural or logical changes may be made without departing from the scope of the claimed invention. The following Description, therefore, is not to be taken in a limiting sense, and the scope of the present invention is defined by the appended claims.

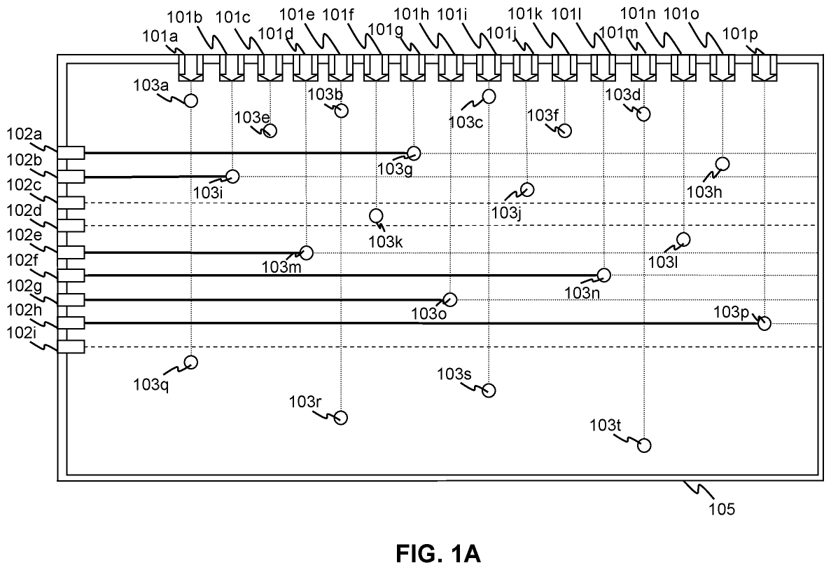

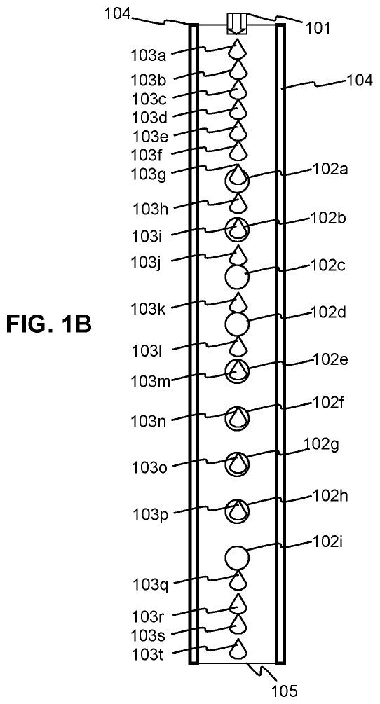

FIG. 1A shows a front view of an implementation of the fluid display device. The present disclosure comprises a row of droplet emitters or outlet nozzles, 101a through 101p, and a vertical row of light emitters, 102a through 102i. This implementation uses a horizontal row of droplet emitters 101, but other configurations are possible, such as a row at a different angle or a series of droplet emitters that are not in a line. Gravity will accelerate the droplets in a downward direction, so typically the droplet emitters will emit droplets straight down. In some implementations, the droplet emitters 101 will emit droplets at another angle, in which case the droplet will travel in an approximately parabola-shaped path instead of a straight line. The same droplet would then line up with different vertical columns of the display image as it falls instead of following the path of a single display column. This implementation uses a vertical row of light emitters 102, but other configurations are possible, such as a row at a different angle, or a series of light emitters 102 that are not in a line. Typically, the light emitted from the light emitters 102 would be in the horizontal direction, but other orientations are possible. In one implementation, the nozzles release the droplets in a non-vertical direction, causing the droplets to fall in a parabolic arc as they are accelerated by gravity. The light emitters can be arranged along this same arc to create a display that is in the shape of a plane that is curved into a parabola. In other implementations, the light may travel through the display area and line up with different rows of the display image instead of following the path of a single display row. The light emitters are configured to illuminate the liquid droplet such that each liquid droplet is a discrete section of an image. In most cases a discrete section of the image corresponds to a pixel but aspects of the present disclosure are not so limited and a in some cases a discrete section may correspond to a block, macroblock of pixels, etc. Where a block is an 8×8 square of pixels and a macroblock is a 16×16 square of pixels.

While this FIG. 1A shows an implementation having 16 columns of droplet emitters 101 and 9 rows of light emitters 102 for illustrative purposes, combinations of any numbers of columns and rows is possible, with typical implementations having a larger number of columns and rows. The ratio of width to height in this implementation is 16×9, which corresponds to the width to height ratio of an HDTV television signal. Such a ratio would be useful for an implementation used to display a signal in a format typically used for television, but other ratios are possible.

In the implementation depicted in FIG. 1A the horizontal spacing between the droplet emitters 101 is the same as the vertical spacing between the light emitters 102. This is a useful case for many implementations as it produces a 1-to-1 aspect ratio for the pixels in the display, which corresponds to the aspect ratio used in televisions and computer monitors, along with the signals that drive them. Implementations with other aspect ratios are possible. Source signals with a different aspect ratio than the display implementation can be mapped to the pixels of the display such that the aspect ratio of the source is preserved in the displayed image.

FIG. 1A shows droplets 103a through 103t that were emitted by the droplet emitters 101 at regular intervals of time. The droplets are shown closer together vertically towards the top of the figure because as a droplet falls its speed increases due to the pull of gravity. The longer a droplet falls the faster the droplet will be traveling, which will cause the droplets towards the bottom of the display to be further apart vertically than they are towards the top of the display. If the droplets are emitted at a consistent rate at a speed below their terminal velocity they will accelerate as they fall and become further apart vertically the longer they fall, which corresponds to the increasing spacing from top to bottom of the droplets 103 in FIG. 1A.

The droplets shown in FIG. 1A are illustrative of an implementation where the order in which the droplets 103 are emitted jumps around instead of in a regular pattern such as sequentially from the leftmost droplet emitter 101a to the right most droplet emitter 101p. The random pattern of droplet emission produces a more random looking pattern of falling droplets 103 that may appear more like rainfall than droplets falling in organized regular pattern. Such an implementation is good for a general-purpose display where the droplets are not intended to distract from the image being displayed. In some implementations, the droplets may be released in a pattern that is perceptible to the viewer, a pattern that varies over time, or that switches between perceptible patterns and non-perceptible patterns. Such a display may be desirable as the patterns of falling droplets can draw the attention of the viewer and make a more impactful display where it is more noticeable that the image is being displayed by a waterfall.

Air resistance may tend to dampen the acceleration of the liquid droplets 103, which increases as the speed of the droplet increases. The air resistance and gravitational acceleration are in equilibrium when the liquid droplet is traveling at its terminal velocity. The longer a droplet falls, the closer to its terminal velocity its speed will be. If droplets are emitted at terminal velocity, or achieve terminal velocity by the time they reach the first light emitter, then they will maintain a consistent speed and spacing as they fall past the light emitters. In some implementations of the present disclosure, the outlet nozzles may emit the liquid droplets at terminal velocity. In other implementations, the droplets may be released at a velocity above their terminal velocity. The outlet nozzles may be configured to output liquid droplets at terminal velocity through for example and without limitation a piezoelectric micro-diaphragm or a small heating element. In other implementations, the pressure of the liquid at the outlet nozzle is high enough that droplets are emitted at terminal velocity. In some implementations, the droplets can be released at higher initial velocity by using airflow in the vicinity of the nozzles to accelerate the droplets as they are released. In some implementations, this airflow will be constant, while in other implementations the airflow will only be present for a short period of time as each droplet is released. In some implementations, a physical mechanism can be used to push the droplet as it is being released or just after it is released to increase its initial velocity. For example without limitation, a spinning water wheel or a paddle mechanism could push droplets to increase the droplet's initial velocity.

The dotted vertical lines from each droplet emitter 101 show the path that the droplets emitted by that emitter will follow. The dashed horizontal lines shown to the right from each light emitter 102 show the path that the light emitted by that light emitter will follow. The full horizontal lines shown to the right from some of the light emitters 102 show the light beam emitted by that light emitter to intersect a droplet 103. For example, the light beam emitted by light emitter 102a illuminates the droplet created by the seventh droplet emitter 103g. The corresponding light beam will have the intensity and coloration corresponding to the seventh pixel over on the top row of the image being displayed.

FIG. 1B is a side view of the liquid display device according to aspects of the present disclosure. The horizontal row of outlet nozzles 101 each emits liquid droplets 103a through 103t independently so that no two droplets share the same space during operation. The light emitters 102a through 102i illuminate the liquid droplets horizontally. The horizontal illumination of the falling droplets creates horizontal rows of pixels when viewed from a direction perpendicular to the plane of falling drops. Each pixel is a liquid droplet illuminated by a light beam. The timing of the illumination of the droplets 103 by the light emitters 102a-102i is determined by the location of each pixel and the timing of emission of the liquid droplets from the outlet nozzles 101. The locations of the outlet nozzles 101 determine the horizontal locations for the pixels and the locations of the light emitters 102a-102i determine the vertical locations of the pixels.

The image created by the display is updated rapidly to ensure that the image is coherent. In one implementation, each outlet nozzle in the horizontal row of liquid outlet nozzles emits droplets at least once every 24 times per second. For larger displays and smoother image reproduction higher emission rates hereinafter referred to as refresh, rates are desirable. A refresh rate of between 60 and 100 times per second may produce smoother, more comprehensible images.

Wind and environmental conditions may affect the quality of images displayed; as such, a transparent material 104 may be placed on either side of the falling liquid droplets to shield them from such environmental effects. In implementations that are intended to be viewed only from one side, the material 104 on the backside of the display can be made of a material that does not allow the display to be viewed through the material. The transparent material 104 may be part of an enclosure 105 that surrounds the liquid display device. The transparent material 104 may be glass, plastic, ceramic, transparent metal, greased paper or any transparent material sufficient to block wind while not blocking light. In some implementations, the enclosure 105 may be sealed from the surrounding environment. The seal may be an airtight seal and in some implementations, the air-pressure within the enclosure may be less than the air-pressure outside the enclosure. Reducing the air-pressure in the enclosure may allow for faster refresh rates because the falling liquid droplets will have a higher terminal velocity. In implementations with reduced air-pressure, boiling of the liquid may be a problem therefore a liquid with a lower vapor pressure/higher boiling point may be used, sublimation may also be a problem and in such cases a liquid with a higher vapor pressure may be used.

By way of example, and not by way of limitation, the liquid emitted from the outlet nozzles 101 may be any material that is a liquid at room temperature. The liquid may be for example and without limitation, water, mineral oil (alkanes or cycloalkanes), alcohol, or carboxylic acid in general a suitable liquid will have a lot of internal reflection/refraction so that there is a wide viewing angle. If there are zero internal reflections, then the light would pass through and there would be no light dispersed in the direction of the viewer. It should be noted that higher viscosity liquids would form droplets slower and as such affect the refresh rate. Additives may be combined with the liquid to improve display performance or provide additional effects. For example and without limitation, ethylene glycol or propylene glycol may be added to a water display to increase the boiling of the mixture, fluorescent or phosphorescent dye may be added to liquid to enhance the effect of the light emitters. In implementations using fluorescent dyes, the light emitters may be in the infrared or ultraviolet spectrum. Such implementations would show no visible light along the edges or top of the display. In some implementations the nozzles may incorporate gas bubbles into the droplets as they are emitted, which can give the droplets a cloudy appearance that disperses light more evenly.

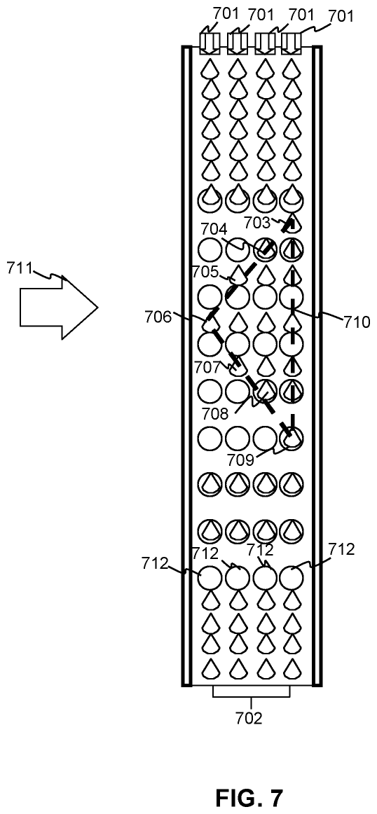

To create a three-dimensional effect several horizontal rows of outlet nozzles may be stacked next to each other in the shorter horizontal dimension as shown in FIG. 7, which is a side view of the fluid display device having stacked outlet nozzles. Thus, several vertical planes of falling liquid droplets stacked next to each other in the shorter horizontal direction 702 are created. Each horizontal row of outlet nozzles 701 may have a set of light emitters 712 that illuminate the liquid droplets independently. Stacking multiple planes of falling liquid droplets acting as pixels in a display effectively creates actual depth as different images may be projected on each layer of the image. The horizontal rows of liquid outlet 701 nozzles may be synchronized to emphasize the three-dimensional nature of the image created by the display. Actual depth from the display device is created through synchronization of the outlet nozzles. As shown in FIG. 7 a triangle or pyramidal shape 710 is formed by synchronizing output of the nozzles. The effect of this formation would be that whatever is projected on the image would appear to pop out towards the viewer in the view direction 711. Droplets 703 and 709 form the top and bottom vertices of the triangle and would appear to be deeper in the image than droplet 706 which is the apex vertex and closest to the viewer in the viewing direction. Droplets 704, 705, 707 and 708 form the rising and falling edges of the pyramidal shape and contribute to the overall depth effect. While the FIG. 7 is shown as being viewed in one direction, aspects of the present disclosure are not so limited, many outlet nozzles could be stacked together and synchronization could be mirrored on both viewing sides. A triangular or pyramidal shape is provided as an example and implementations of the present disclosure are not so limited, liquid emitters could be synchronized to create any three-dimensional primitive in with the liquid droplets. In some implementations, the liquid droplets are synchronized with a depth mapping of an image in an image buffer.

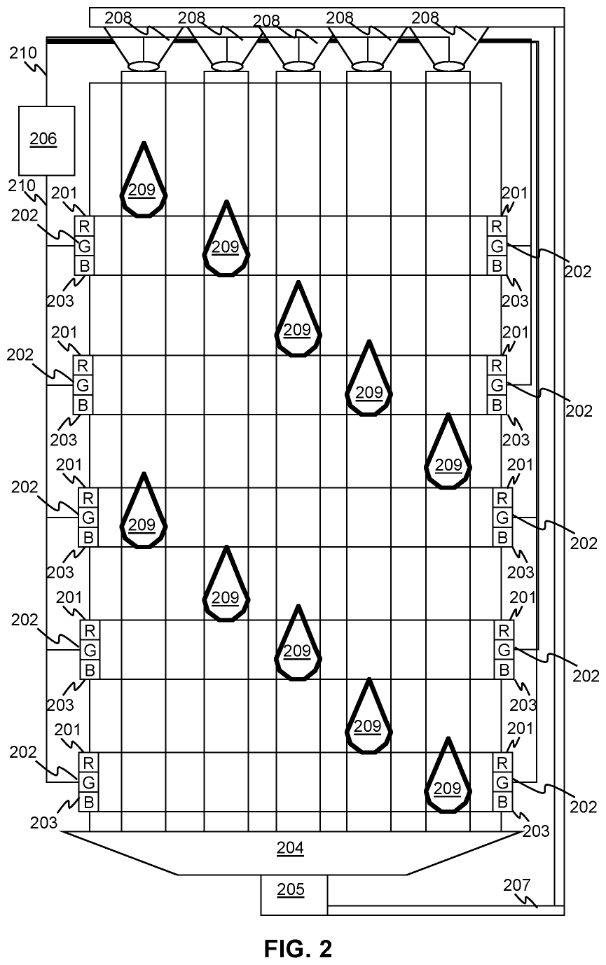

FIG. 2 shows a full color fluid display according to aspects of the present disclosure. As shown, a full color display may be achieved, e.g., by arranging red 201 green 202 and blue 203 light emitters to project in the same row of droplets 209. In the implementation shown the red 201, green 202 and blue 203 light emitters are organized in vertical sets for each horizontal row but aspects of the current disclosure is not limited to such implementations. The red 201 green 202 and blue 203 light emitters may be arranged in any order and orientation suitable to project colored light on to the droplets 209. In some implementations the red 201, green 202, and blue 203 light emitters are arranged horizontally with three emitters in each row. In some implementations, the beam emitted by the light emitters can be wider front-to-back than it is top-to-bottom. Such an implementation can have the advantage that if air currents cause a droplet to deviate from a purely vertical path, the wide beam provides for a margin of error so that the droplet will be properly illuminated even if it is not fully in the plane of the display by the time it falls to the height of the light beam. Such an implementation can be achieved by having multiple copies of each light emitter 201, 202, and 203 alternating in a row at the level in which the light should be emitted. In another implementation the light from light emitters 201, 202, and 203 are combined into a single beam that can be emitted through the same lens element. Such an implementation can be used to ensure a tight image beam with uniform reflections of the light from each emitter 201, 202, and 203 in each direction. Implementations of the present disclosure are not limited to red green and blue emitters, other implementations may use for example red and green emitters or any desired color combination of emitters. As shown, the light emitters are arranged on both sides of the horizontal row outlet nozzles 208. Arranging the light emitters on both sides of the outlet nozzles facilitates even illumination of the liquid droplets 209. Droplets evenly illuminated from two sides are more easily viewable from all viewing angles than droplets illuminated from one side.

A controller 206 may be communicative coupled 210 to the light emitters 201, 202, 203 and outlet nozzles 208 through for example and without limitation a serial cable, a bus bar, Ethernet cable or any other suitable connection type. The controller may be configured to receive image frames and convert the images frames to time synchronized signals sent to the light emitters. This conversion can be done by determining the timing for when each droplet will fall past each light emitter and using the light levels for the corresponding pixel from the image frame to illuminate the light emitter at that time. The image frames may be part of a stream of image frames in a video stream. Alternatively, the image frame may be a still image. In some implementations, the controller is coupled to the light emitters and the outlet nozzles are controlled independently. In this implementation, the controller may be calibrated to generate an independent representation of the pattern and timing of fluid droplets created by the outlet nozzles. In other implementations, the timing of the drops may be calculated from the signals sent to the nozzles to control the release of the drops. In some implementations, the timing of the drops is determined from measurements of the drops. By having two sensors between each nozzle and the first light emitter the timing of when the droplets released passes each sensor can be measured, thus giving both the time when the droplet passed by the bottom sensor and the velocity in which the droplet was falling. Such measurements of the droplets can be used to compensate for changes in nozzle behavior over time, such as from a buildup of mineral deposits. Such measurements can be used in conjunction with the signals sent to the nozzles to automatically perform calibration that compensates for differences in behavior from one nozzle to the next. Such sensors can be implemented as a beam and detector that can detect when the droplet crosses the path of the beam. Such sensors can be implemented using cameras, in which case a single sensor may be used to detect both timing and velocity. In some cases, a single camera can be used as the sensor for the droplets from multiple nozzles.

A more organized droplet 209 pattern is shown in FIG. 2 may make it easier to calculate droplet position for displaying images. Here, the droplets are emitted sequentially in waves and fall in diagonal lines. With this implementation, the rate of emission of liquid droplets may match the refresh rate of the video images being projected on to the liquid. Thus as the liquid droplets fall the light emitters sequentially project the pixels of the image frame on to the waves based on timing. The droplet pattern is imperceptible given just the illumination of the droplets without outside lighting sources. Under some lighting conditions external light may expose the pattern or variations of the pattern based on the lights flicker rate. Under truly consistent light, such as sunlight, each outlet nozzle will be seen to produce a stream. While a drawback of this implementation is that the wave fronts may create a noticeable pattern, at least in some embodiments the rate of emission may be high enough that the wave fronts are imperceptible.

Additionally shown in FIG. 2 are support structures for the liquid display device. The support structures may include a reservoir 204, which is refilled by the falling liquid droplets 209, a pump 205 to push or pull the liquid to the outlet nozzles 208, and plumbing 207 to carry the liquid to the outlet nozzles 208. The reservoir 204 may include a reservoir tank or pool. The pump 205 may be any liquid pump sufficient to transfer the liquid from the reservoir to the outlet nozzles through the plumbing. While a recirculating fountain type system is shown, other implementations are also possible. For example and without limitation, in some implementations the reservoir may include a drain and the liquid supplied to the outlet nozzles may be supplied independently from liquid in the reservoir.

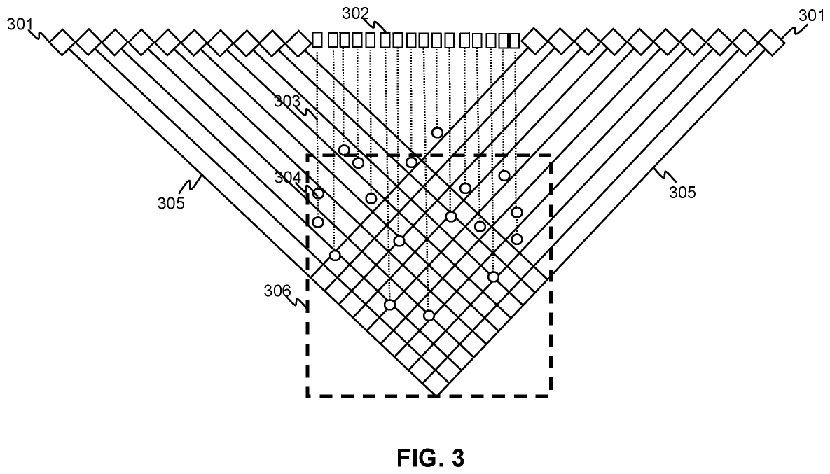

FIG. 3 shows another, alternative implementation of the current disclosure. In this implementation, the light emitters 301 are mounted horizontally above the vertical travel path 303 of the liquid droplets 304. The light emitters 301 are angled to illuminate the liquid droplets along diagonals 305. The liquid outlet nozzles 302 are mounted inline horizontally with the light emitters 301 and are aligned with the area with the display area 306. The display area 306 may encompass the location underneath the liquid outlet nozzles where the diagonally pointing light emitters intersect. Specifically the area in which the light from the light emitters intersect is the diamond area within area 306. In this area, the liquid droplets will be most evenly illuminated and more visible. The image in the corners of area 306 will only receive light from the emitters on one side. In some implementations, area 306 can be used to display the image, with some of the droplets lit only from one side. While in other implementations, an area within the area where the light from the light emitters intersects can be used for the display, allowing each pixel to be illuminated from a light emitter on the left side and a light emitter on the right side for a more uniform field of view. This area could be limited to a 19×9 rectangle to display a standard HD TV signal, or it could be any other shape that fits in that area. In other implementation areas outside the display area may be used as part of displayed images, in this case the portions of the image outside of the display area would be dimmer and less visible from some angles. This result could be used to create interesting effects in the display.

A benefit of the implementation shown in FIG. 3 is that the light emitters can be mounted above the display area and therefor easily be hidden from view. This would allow for seamless liquid displays having the liquid nozzles and light emitter mounted to a ceiling and the liquid reservoir placed in the floor or on a table. Return pumps and plumbing are hidden in the floors and walls of the building thus creating a display that appears to be floating on falling liquid droplets.

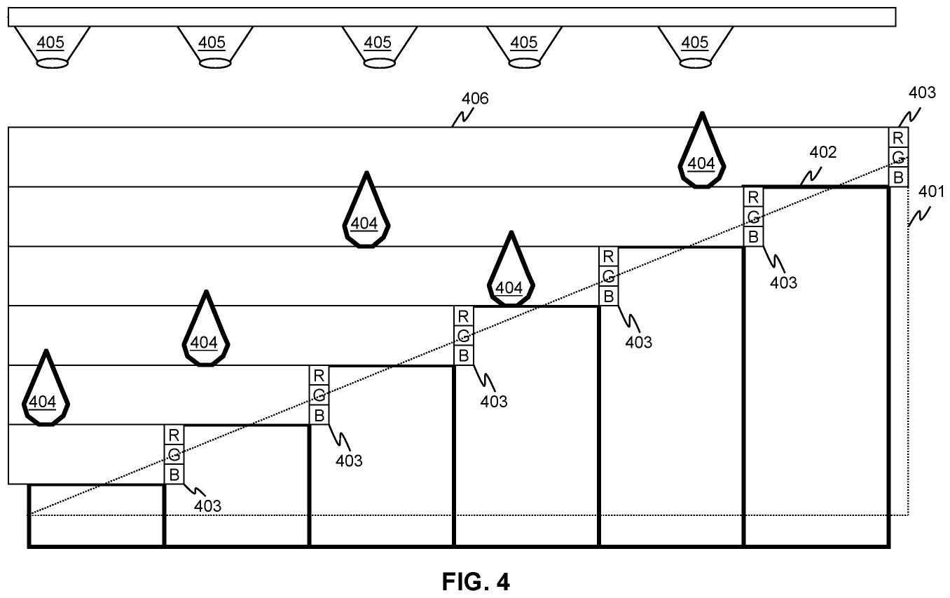

FIG. 4 depicts yet another implementation of the current disclosure. In this implementation, the light emitters are mounted on an inclined plane. The inclined plane 401 may be a set of stairs 402 with the light emitters 403 mounted in each rise and pointing in horizontal rows 406 along the vertical travel path of the liquid droplets 404. The liquid droplets are emitted from a horizontal row of liquid outlet nozzles 405. The horizontal row of outlet nozzles 405 emit the liquid droplets 404 in a horizontal rows that travel vertically downward with the pull of gravity. The outlet nozzles 405 may be configured to emit liquid droplets in patterns as discussed above. The outlet nozzles may be spaced so that there is one or more nozzle per vertical step. In this way, the liquid display device may be integrated into stairways or on hillsides. In some implementations the row of nozzles are not in a horizontal line. For the example of a display on the railing of a staircase, the nozzles could be in an angled line under the banister, while the light emitters could be in a vertical line at the top and/or bottom of the stairs, with the angle of the light they emit similar to the angle of the banister. In other implementations, the nozzles or light emitters do not need to be arranged in a line. For example, the top of the display could be in an arch shape, in which case the nozzles could be arranged to follow the arch. In another example, the frame of the display could be circular, in which case both the nozzles and light emitters would be arranged in a circular arch.

In some implementations, the velocity at which the droplets emitted by a first nozzle can differ from the velocity at which the droplets emitted by a second nozzle are emitted. Such differences can be used, for example, in an implementation where the nozzles are in an angled line, but the light emitters are in a vertical line projecting horizontal beams of light. By releasing the droplets from the lower nozzles at a higher velocity than the droplets released from higher nozzles it can compensate for the fact that the droplets released by the higher nozzles were accelerated by gravity before they reached the height of the lower nozzles. This can be used to have the droplets pass the first light emitter with a constant velocity. Such an implementation can also work well when the nozzles are arranged in a stair-step pattern consisting of multiple horizontal lines at differing heights. Releasing droplets at differing velocities can also be used to create eye-catching patterns in the falling droplets.

In some implementations, the nozzles can be used to emit droplets in a pattern that is meant to draw the attention of the viewer. If such a pattern is emitted when no image is being displayed, such as the blank interval between scenes in a video program, then multiple droplets can be emitted at the same time, as there is no concern with droplets obscuring light beams. Such a display can be interspersed with video display to better grab viewer's attention and break up the monotony of a continuous video display.

Conversion of Image Frames to Fluid Images

Initially, calibration data may be used to determine the speed and trajectory of liquid droplets emitted from the system. Ideally, each outlet nozzle would emit liquid with the same volume and vertical speed but due to fluid dynamics, such consistency is unlikely therefore, some initial calibration data is required. Calibration may be performed using a camera and a light source to track the trajectory and speed of the falling droplets.

Once the speed and trajectory of the falling droplets is sufficiently tracked, the information may be used to generate an internal representation of the falling droplets. The internal representation of the falling droplets may then be mapped to the image frame through a series of time steps.

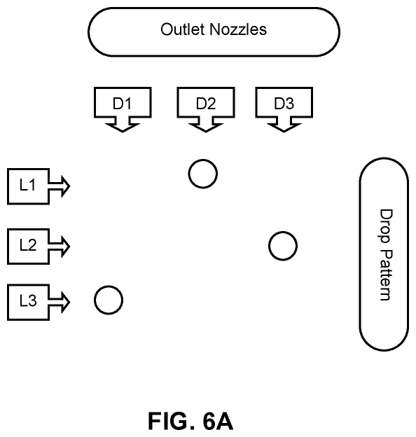

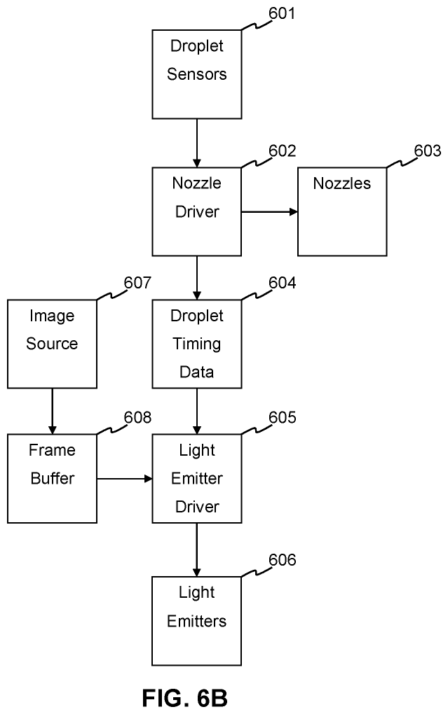

For example and without limitation, the image is present in an image buffer with data, e.g., chroma and luma data for pixels arranged in an xy plane as is common for most computer graphic systems. In another buffer there is arranged by delta-time from the start of the frame a pointers to a piece of image data from the image frame and an index to the light emitters (RGB, etc.) set to illuminate. This data is pre-calculated possibly during a calibration phase such that every pixel in the image frame is presented. The image may be masked for displays that do not have a strictly horizontal rectangular display area. FIG. 6A schematically an Example of a drop pattern mapping for outlet nozzles D1, D2, D3 and light emitters L1, L2, L3 to pixel locations in an image buffer.

In example illustrated in FIG. 6A, the mapping of Light Emitter→Pixel locations in the Image buffer may be expressed as:
I₁→1,3 2,3 3,3
I₂→1,2 2,2 3,2
I₃→1,1 2,1 3,1

Thus, the command table of the falling droplet pattern in FIG. 6A at terminal velocity would look like:

DT₁: Image 1,3 to I₁; Image 2,2 to I₂; Image 3,1 to I3; Nozzle D₃

DT₂: Image 3,3 to I₁; Image 1,2 to I₂; Image 2,1 to I3; Nozzle D₂

DT₃: Image 2,3 to I₁; Image 3,2 to I₂; Image 1,1 to I3; Nozzle D₁

Where DT_{1 . . . n} represents a drop times, I1 . . . ₙ represents light emitters and D_{1 . . . n} represent outlet nozzles. In the above example drop times or delta-time corresponds to the time it takes for a drop to travel the distance from one light emitter row to the another light emitter row and the drop pattern loops indefinitely. In some implementations, the drop times are not synchronous with illumination times and may be offset as T0.5, T1.4 etc. In other implementations the drop pattern is varied based, a predefined pattern map. The pattern map may simply be an array similar to the one above showing drop location at delta times.

FIG. 6 is a block diagram of the conversion of image frames to fluid images. This implementation shows the use of droplet sensors 601 that are used for the calibration of the nozzle driver 602, and can also improve the accuracy of the droplet timing data 604 that the nozzle driver produces. The droplet sensors 601 are optional, in which case the droplet timing data produced by the nozzle driver 602 will be based on the timing of the commands that it sends to the nozzles 603. The nozzle driver is responsible for the timing of the signals to the nozzles 603 and for generating the pattern in which the droplets are released. The image source 607 is the data that defines the image being displayed. In some cases, this is a static image. In other cases, this is a video signal, such as a signal that would be used to drive a television display. In other cases, the image source can be procedurally generated, such as patterns synchronized to music, or the output of a video game.

The frame buffer 608 contains the illumination value for each pixel for the current image being displayed. In some instances, the frame buffer may also contain the illumination for each pixel in more than one frame, allowing access to upcoming and/or previous illumination values. The light emitter driver 605 uses the droplet timing date 604 to determine when each droplet will pass through the path of the light beam from each light emitter. For each droplet, passing through a light beam the light emitter driver will then get the illumination level for the corresponding pixel in the display from the frame buffer 608 and send that information to the appropriate light emitter 606 to have the beam illuminate the droplet with the proper value for the pixel.

In some implementations, there is not a one to one mapping between the pixels in the frame buffer and the pixels in the display. This can be the case if the image source provides an image that is a different size or aspect ratio than the display. This can also be the case if the display area is not rectangular, such as when the display area is a trapezoid. In such a case, the display area may be scaled to the size of the frame buffer and the pixels that do not correspond to the scaled display area in the frame buffer can be ignored, such as displaying a trapezoid area out of a rectangular TV signal, and ignoring the rest of the area. In the case where there is not a one to one mapping the light emitter driver can take care of any scaling or masking needed to translate the image data in the frame buffer to determine the pixel illumination for each pixel in the display.

In some implementations, a control unit (not shown) will determine the image source to use and the pattern that the nozzle driver should use to release the droplets. The controller may change these values over time, such as to vary the display between displaying images and displaying patterns of falling water to be of more interest to viewers. The control unit can also control external lighting so that when the display is being used to display a pattern of droplets and not display image data, lighting near the display can be increased to make the pattern of water droplets more noticeable.

Implementation

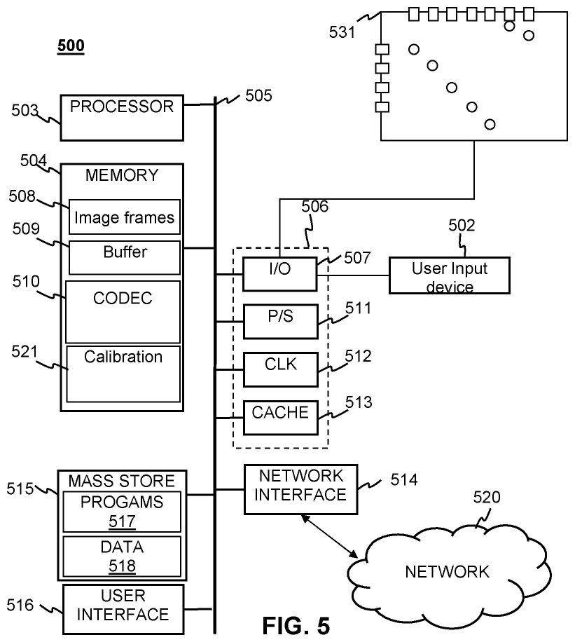

FIG. 5 depicts a system according to aspects of the present disclosure. The system may include a computing device 500 coupled to a user input device 502. The user input device 502 may be a controller, touch screen, microphone, keyboard, mouse, joystick or other device that allows the user to input information including sound data in to the system. The fluid display device 531 may be communicatively coupled to the computing device 500 through the input/output (I/O) interface 507.

The computing device 500 may include one or more processor units 503, which may be configured according to well-known architectures, such as, e.g., single-core, dual-core, quad-core, multi-core, processor-coprocessor, cell processor, and the like. The computing device may also include one or more memory units 504 (e.g., random access memory (RAM), dynamic random access memory (DRAM), read-only memory (ROM), and the like).

The processor unit 503 may execute one or more programs, portions of which may be stored in the memory 504 and the processor 503 may be operatively coupled to the memory, e.g., by accessing the memory via a data bus 505. The programs may be configured to generate calibration data 521 and convert image frames 508 to a form that is displayable on the fluid display device 531. Additionally the Memory 504 may contain programs that implement encoding and decoding of image frames 510.

The calibration data and other synchronization information may also be stored as data 518 in the Mass Store 515. The processor unit 503 is further configured to execute one or more programs 517 stored in the mass store 515 or in memory, which cause the processor to carry conversion of image frames to fluid display image.

The computing device 500 may also include well-known support circuits, such as input/output (I/O) 507, circuits, power supplies (P/S) 511, a clock (CLK) 512, and cache 513, which may communicate with other components of the system, e.g., via the bus 505. The computing device may include a network interface 514. The processor unit 503 and network interface 514 may be configured to implement a local area network (LAN) or personal area network (PAN), via a suitable network protocol, e.g., Bluetooth, for a PAN. The computing device may optionally include a mass storage device 515 such as a disk drive, CD-ROM drive, tape drive, flash memory, or the like, and the mass storage device may store programs and/or data. The computing device may also include a user interface 516 to facilitate interaction between the system and a user. The user interface may include a monitor, Television screen, speakers, headphones or other devices that communicate information to the user.

The computing device 500 may include a network interface 514 to facilitate communication via an electronic communications network 520. The network interface 514 may be configured to implement wired or wireless communication over local area networks and wide area networks such as the Internet. The device 500 may send and receive data and/or requests for files via one or more message packets over the network 520. Message packets sent over the network 520 may temporarily be stored in a buffer 509 in memory 504.

While the above is a complete description of the preferred embodiment of the present disclosure, it is possible to use various alternatives, modifications and equivalents. It is to be understood that the above description is intended to be illustrative, and not restrictive. For example, while the flow diagrams in the figures show a particular order of operations performed by certain embodiments of the disclosure, it should be understood that such order is not required (e.g., alternative embodiments may perform the operations in a different order, combine certain operations, overlap certain operations, etc.). Furthermore, many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the spirit and scope of the appended claims. The scope of the disclosure should, therefore, be determined with reference to the appended claims, along with the full scope of equivalents to which such claims are entitled. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A fluid display device, comprising:
a plurality of outlet nozzles configured to emit liquid droplets, wherein the outlet nozzles are arranged in a row;
a plurality of light emitters aligned with a vertical travel path of the liquid droplets and coplanar with a vertical plane of the falling liquid droplets, wherein the plurality of light emitters are configured to illuminate the liquid droplets;
a controller configured to synchronize illumination of the liquid droplets by the plurality of light emitters with pixels in an image, and wherein a pattern of the illumination of the liquid droplets creates a visible image in the vertical plane of the falling liquid droplets.

2. The fluid display device from claim 1, wherein the plurality of light emitters further comprise red, green and blue light emitters.

3. The fluid display device from claim 2, wherein the plurality of emitters are arranged in horizontal rows with 1 red, 1 green and 1 blue light emitter in each horizontal row.

4. The fluid display device from claim 2, wherein the plurality of emitters are arranged in vertically aligned sets for each horizontal row and wherein each set has at least 1 red, at least 1 green and at least 1 blue light emitter.

5. The fluid display device from claim 1, wherein the plurality of light emitters are light emitting diodes.

6. The fluid display device from claim 1, wherein the plurality of light emitters are laser diodes.

7. The fluid display device from claim 1, wherein the plurality of light emitters are arranged in a stacked vertical configuration and wherein the plurality of light emitters are configured to illuminate horizontal rows along the vertical travel path of the liquid droplets.

8. The fluid display device from claim 1, wherein the plurality of light emitters are arranged in a horizontal row and wherein the plurality of light emitters are configured to illuminate diagonals within the vertical plane created by the falling liquid droplets.

9. The fluid display device from claim 1, wherein the plurality of light emitters are arranged on an inclined plane and wherein the plurality of light emitters are configured to illuminate rows along the vertical travel path of the liquid droplets.

10. The fluid display device from claim 9, wherein the inclined plane is a staircase.

11. The fluid display device from claim 1, wherein the plurality of light emitters are arranged on both horizontal sides of the plurality of output nozzles and configured to illuminate the liquid droplets from at least two directions.

12. The fluid display device from claim 1, further comprising a plurality of horizontal rows of outlet nozzles stacked next to each-other in the shorter horizontal dimension on the horizontal plane and wherein each row in the plurality of horizontal rows of outlet nozzles has a plurality of light emitters coplanar with the vertical plane created by the falling liquid droplets and configured to illuminate the liquid droplets in the vertical plane.

13. The fluid display device from claim 1, wherein the liquid is water.

14. The fluid display device from claim 1, wherein the outlet nozzles emit liquid droplets at a terminal velocity for the liquid droplets.

15. The fluid display device from claim 1, further comprising an enclosure surrounding the vertical travel path of the falling liquid droplets and having a transparent material on at least one side and out of plane of the vertical plane created by the falling liquid droplets.

16. The fluid display device from claim 15, wherein the interior of the enclosure is at a pressure lower than the ambient atmospheric pressure.

17. The fluid display device of claim 1, wherein the outlet nozzles are configured to emit the liquid droplets in a non-vertical direction, wherein the vertical plane created by the falling droplets is a curved parabola and the light emitters are arranged along the curved parabola.

18. A system for fluid display, comprising:
a fluid display comprising:
a plurality of outlet nozzles configured to emit liquid droplets, wherein the outlet nozzles are arranged in a row;
a plurality of light emitters aligned with a vertical travel path of the liquid droplets and coplanar with a vertical plane of the falling liquid droplets, wherein the plurality of light emitters are configured to illuminate the liquid droplets;
a processor coupled to the fluid display;
memory coupled to the processor;
non-transitory executable instructions embodied in the memory when executed cause the processor to synchronize illumination of the liquid droplets with the pixels in an image, and wherein a pattern of illumination of liquid droplets creates a visible image in the vertical plane if the falling liquid droplets.

19. The system for fluid display from claim 18, wherein the plurality of light emitters are arranged in a stacked vertical configuration and wherein the plurality of light emitters are configured to illuminate horizontal rows along the vertical travel path of the liquid droplets.

20. The system for fluid display from claim 18, wherein the plurality of light emitters are arranged in a horizontal row and wherein the plurality of light emitters are configured to illuminate diagonals within the vertical plane created by the falling liquid droplets.

21. The system for fluid display from claim 18, wherein the plurality of light emitters further comprise red, green and blue light emitters.
